(19) United States
(12) Patent Application Publication
(10) Pub. No.: US 2012/0281398 A1
(43) Pub. Date: Nov. 8, 2012

(54) DECORATIVE LIGHT STRING

(76) Inventor: Tabitha King, Minot, ME (US)

(21) Appl. No.: 13/103,043

(22) Filed: May 7, 2011

(51) Int. Cl. F21V 9/00

(52) U.S. Cl. 362/231

(57) ABSTRACT

The present invention is a decorative light string that includes electrical wiring utilized to provide power to the light string, an attachment interface that receives the electrical wiring and a plurality of 100 LED lights or more attached to the electrical wiring by the attachment interface, Each LED light includes an elongated rectangular shaped LED light switch that controls illumination of the LED lights, a plurality of colored LEDs that are housed within the light switch that controls illumination of the LED lights and an exterior bulb that encloses the LED light switch and the colored LEDs forming the LED light.

### TECHNICAL FIELD & BACKGROUND

Currently there are limited holiday lighting displays. Typical decorative systems are either produced in specific colors or theme related options, resulting in the tedious necessity of replacing lighting installations after each celebration.

The present invention generally relates to a decorative light. More specifically, the invention is a decorative light string.

It is an object of the invention to provide a decorative light string that can be controlled to display a plurality of colors and hues.

It is an object of the invention to provide a decorative light string that is an alternative permanent or temporary lighting installation.

What is really needed is a decorative light string that can be controlled to display a plurality of colors and hues that is an alternative permanent or temporary lighting installation.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side perspective view of a decorative light string, in accordance with one embodiment of the present invention.

FIG. 1B illustrates a side perspective view of a light of a decorative light string, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

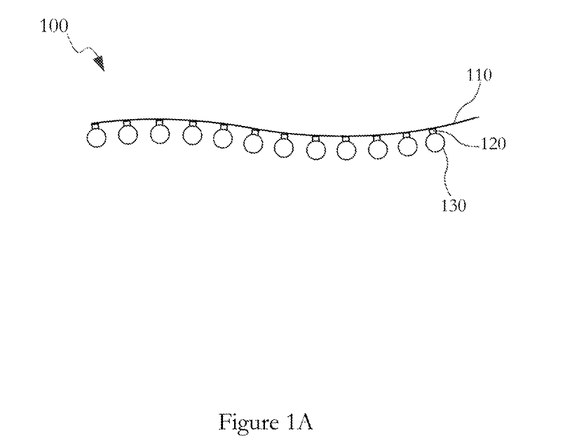

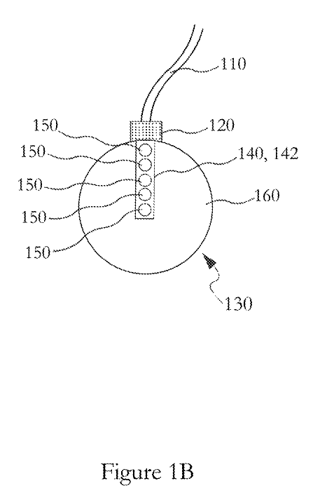

FIG. 1A illustrates a side perspective view of a decorative light string 100, in accordance with one embodiment of the present invention. The decorative light string 100 includes electrical wiring 110, an attachment interface 120 and a plurality of lights 130. The decorative light string 100 is an alternating color decorative light string that can be utilized for holiday lighting or other suitable purposes. The decorative light string 100 can be permanently or temporarily installed.

The electrical wiring 110 is utilized to provide electrical power to the lights 130. The attachment interface 120 receives the electrical wiring 110 and attaches each of the lights 130 to the electrical wiring 110. The lights 130 are LED lights 132 and include approximately 100 or more lights 130 attached to the electrical wiring 110, although any suitable number of lights 130 can be attached to the electrical wiring 110. Any other suitable type of lights can also be attached to the electrical wiring 110. Further details regarding the lights 130 are described in FIG. 1B and its description.

FIG. 1B illustrates a side perspective view of a light 130 of a decorative light string 100, in accordance with one embodiment of the present invention. The light 130 includes an LED light switch 140, a plurality of colored LEDs 150 and an exterior bulb 160. The LED light switch 140 has an elongated rectangular shape 142, although other suitable shapes can also be utilized. The LED light switch 140 houses the lights 130 and controls the illumination of the LED light 132. The illumination can be alternatingly twinkling, periodic blinking or sequential recycling along the length of the LED light switch 140. The colored LEDs 150 are housed in the LED light switch 140 and can be red, clear, green, blue, orange or any other suitable colors. The exterior bulb 160 encloses the LED light switch 140 and colored LEDs 150 and is round-shaped, however the exterior bulb 160 that can be any other suitable decorative shape such as a star or a holiday figure.

The decorative light string is a multiple spectrum lighting system that offers an innovative approach to traditional holiday decorations. Made from an internal LED light switch, surrounded by an exterior round bulb, the decorative light string exhibits color variations in clear, red, green, blue, purple and orange lighting. Powered by electricity, the decorative light string is controlled by a setting function of the LED light switch allowing users to select showcasing options of independent or collaborative color designs that also twinkle, blink or recycle the lighting spectrums. The decorative light string can be a hanging display with 100 bulbs or more per decorative light string. The decorative light string displays appropriate celebratory hues and affords decorating enthusiasts with an alternative permanent or temporary lighting installation.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A decorative light string, comprising:
electrical wiring utilized to provide, power to said light string;
an attachment interface that receives said electrical wiring;
a plurality of LED lights attached to said electrical wiring by said attachment interface;
an LED light switch that controls illumination of said LED lights;
a plurality of colored LEDs that are housed within said light switch; and
an exterior bulb that encloses said LED light switch and said colored LEDs forming said LED light.

2. The string according to claim 1, wherein there are approximately 100 LED lights attached to said wiring to form said light string.

3. The string according to claim 1, wherein said light switch has an elongated rectangular shape.

4. The string according to claim 1, wherein said illumination includes alternatingly twinkling, periodic blinking or sequential recycling of said LED lights,

5. The string according to claim 1, wherein said exterior bulb is round-shaped.

6. The string according to claim 1, wherein said light string is permanently installed.

7. The string according to claim 1, wherein said light string is temporarily installed.

8. A decorative light string, comprising:
electrical wiring utilized to provide power to said light string;
an attachment interface that receives sad electrical wiring;
a plurality of LED lights attached to said electrical wiring by said attachment interface;
an LED light switch that controls illumination of said LED lights;
a plurality of colored LEDs that are housed within said light switch that controls illumination of said LED lights; and
an exterior bulb that encloses said LED light switch and said colored LEDs forming said LED light.

9. The string according to claim 8, wherein there are approximately 100 LED lights or more attached to said wiring to form said light string.

10. The string according to claim 8, wherein said light switch has an elongated rectangular shape.

11. The string according to claim 8, wherein sad illumination includes alternatingly twinkling, periodic blinking or sequential recycling of said LED lights.

12. The string according to claim 8, wherein said exterior bulb is round-shaped.

13. The string according to claim 8, wherein said light string is permanently installed.

14. The string according to claim 8, wherein said light string is temporarily installed,

15. A decorative light string, comprising:
electrical wiring utilized to provide power to said light string;
an attachment interface that receives said electrical wiring;
a plurality of approximately 100 LED lights attached to said electrical wiring by said attachment interface;
an elongated rectangular shaped LED light switch that controls illumination of said LED lights;
a plurality of colored LEDs that are housed within said light switch that controls illumination of said LED lights; and
an exterior bulb that encloses said LED light switch and said colored LEDs forming said LED light.

16. The string according to claim 15, wherein there are more than 100 LED lights attached to said wiring to form said light string.

17. The string according to claim 15, wherein said illumination includes alternatingly twinkling, periodic blinking or sequential recycling of said LED lights.

18. The string according to claim 15, wherein said exterior bulb is round-shaped, is star-shaped or is in a decorative holiday figure shape.

19. The string according to claim 15, wherein said light string is permanently installed,

20. The string according to claim 15, wherein said light string is temporarily installed.
